(19) United States
(12) Patent Application Publication
(10) Pub. No.: US 2004/0215736 A1
(43) Pub. Date: Oct. 28, 2004

(54) Method for notifying a user about the presence of a message stored for him

(75) Inventors: Michael Kortan, Wien (AT); Rudolf North, Kirchschlag (AT); Wolfgang Rittsteiger, Leonding (AT)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/738,979

(22) Filed: Dec. 19, 2003

(30) Foreign Application Priority Data
Dec. 20, 2002 (DE) 10260239.5

(51) Int. Cl. G06F 15/16

(52) U.S. Cl. 709/207

(57) ABSTRACT

A method for notifying a user about the presence of a message (NN) intended for him and stored in one or more storage devices (SE), whereby the status of a storage device (SE) is monitored by a monitoring device (ÜE) and, depending on the result of the monitoring, a notification is generated which indicates the presence of a message (NN) or the number of messages (NN). This notification is subsequently transmitted to a broadcast transmitter device (RSE), broadcast by the broadcast transmitter device (RSE), received by a broadcast receiver device (REE) assigned to the user, forwarded by the receiver device (REE) to the output device (AE) and output on the output device (AE). The invention further relates to a monitoring device (ÜE) which enables the method according to the invention to be implemented.

The invention relates to a method for notifying a user about the presence of messages intended for him and stored in one or a plurality of storage devices, whereby the status of a storage device is monitored by a monitoring device and depending on the result of the monitoring a notification is generated which indicates the presence of a message or the number of messages, in particular the number of new and read messages. The invention further relates to a monitoring device which enables the method according to the invention to be implemented

The leaving of messages and asynchronous communication via messages have become important fixtures of our daily lives, both professionally and privately. E-mails, SMS and voice messages may be cited here as examples. At the same time the list cited represents only a small cross-section of the conceivable possibilities. It is crucial to becoming aware of an incoming message that the corresponding means of communication is ready to operate and receive.

Whereas the reception of, for example, e-mails in commercial operation is usually guaranteed across the board at least during normal working hours, becoming aware of private e-mails represents a problem to the extent that computers for private use are normally started up only on an irregular basis. In certain circumstances a received e-mail may go unread for weeks in this way.

However, the reception of SMS and voice messages, which usually only come about in any case as a result of the desired party not being reachable, is also tied to an operationally ready mobile phone. Since private phones are usually switched off overnight and business phones are switched off outside office hours, it is not possible to deliver a message during these periods. Possibly urgent messages which cannot be received on account of this human habit therefore go undetected.

For this reason there exist according to the prior art extensive possibilities for informing a user about the presence of a message intended for him and stored in a storage device

For example, the presence of a voice message is frequently indicated by the delivery of an SMS which contains a pointer to this situation. The presence of an SMS which cannot be displayed because of, say, a memory overflow in the mobile phone is also indicated for example by a corresponding flashing symbol. Even the arrival of an e-mail is indicated on a computer by means of a so-called “popup window” or a suitable symbol in order to alert the user to this message also during his usual activity, in other words without the need to constantly check the e-mail inbox. The possibilities presented are contingent upon an operationally ready means of communication assigned to the message type, in other words, for example, a mobile phone for a voice message, a computer for an e-mail and so on.

Notification above and beyond these type-related boundaries is also technically possible, however. Thus, for example, notification about the presence of an e-mail to a telephone is known. This service, known by the term “email waiting indication”, is standardized for, say, ISDN, CENTREX and POTS. Although this possibility increases the percentage for a successful, mostly immediate notification, the presence of a plurality of messages nevertheless remains undetected.

The object of the invention is therefore to specify an improved method for notifying a user about the presence of a message intended for him and stored in a storage device.

This takes place according to the invention by means of a method of the kind referred to in the introduction,

wherein this notification, provided with a user-specific identifier, is transmitted by a broadcast transmitter device, in particular on a periodically recurring basis,

wherein this notification is filtered out from the received data according to the user-specific identifier by a broadcast receiver device assigned to the user, and

wherein this notification is output on an output device.

Broadcasting equipment, radio and television for example, is used by a high proportion of the population, and mostly on a regular basis. In the private domain the radio or television receiver mentioned is usually in operation for several hours a day, in other words for a considerably longer time than a privately used computer and also at times when mobile phones are usually switched off.

According to the invention, a notification about the presence of a message, provided with a user-specific identifier, is now transmitted by a broadcast transmitter device in parallel with a program intended for a public audience. A broadcast receiver device assigned to the user receives this data, in other words the program intended for the general public and also all user-specific information, both that intended for the user and that intended for the remaining subscribers Information intended for the general public and information assigned to the user is filtered out from the data stream by this broadcast receiver device and output on an output device. On the other hand, personal information intended for the remaining subscribers is discarded and cannot be accessed by the user.

Possibilities conceivable in this context are for example text messages which are inserted into the current live television program, for example such as: “New message received from subscriber x” or “y unread, z read messages”. Also possible, however, is a voice-based solution in which the notification is delivered in audible form, generated by a voice synthesizer for example. The same also applies to radio reception. Here again, the text-based solution, by presentation on a display of the radio receiver for example, or the voice-based solution, by audible insertion of a notification into the current live program, are possible.

The notification itself is transmitted by the broadcast transmitter device, in particular on a periodically recurring basis, since the readiness to receive of a broadcast receiver device usually can not be guaranteed at all times. If, however, the broadcast receiver device is sure to be in operation continuously, the onetime transmission of the notification also suffices in principle, said notification subsequently being buffered in the broadcast receiver device until it is output on the output device.

It is favorable if, for the purpose of monitoring the status of a storage device, the number of messages intended for a user and stored in the storage device is transmitted periodically by the storage device to the monitoring device, in particular in response to a periodic request from the monitoring device, or if there is a change of status in the storage device.

In a first variant the storage device, which is for example part of a network such as, for instance, the Internet, is constantly contacted by the monitoring device in order to determine the number of messages assigned to a user. In this case the users who have booked the service according to the invention can be administered for example in a database which is also accessible to the monitoring device. This method is also known by the term “polling”. However, the transmission of the data is not necessarily linked to a request from the monitoring device, but can also be initiated by the storage device or storage devices themselves. If a plurality of storage devices are monitored by a monitoring device, provision can also be made for the individual results to be added in order to yield an overall result.

In a second variant the monitoring device is proactively informed by the storage device if there is a change of status in the storage device, in other words as and when there is due cause. With this variant, data is advantageously transmitted by the storage device or storage devices to the monitoring device only when a change has also actually taken place, and not, as in the case of polling, at more or less regular time intervals, irrespective of whether a change in status has occurred. The corresponding data links are therefore subject to comparatively little load.

Different access safeguards can for example be provided in the storage device in this case to ensure that access for the monitoring device remains restricted to the data mentioned, whereas access for the user is basically possible to all the data.

It is also favorable if, for the purpose of monitoring a status of a storage device, a change in Status in the storage device, in particular the arrival of messages, the reading of messages or the deletion of new or already read messages, is transmitted by the storage device to the monitoring device, and the individual status changes are added up accordingly in the monitoring device.

In this case the monitoring device is proactively informed by the storage device about a change in status or transaction, in other words as and when there is due cause. With the aid of the monitoring device a corresponding notification may subsequently be generated, forwarded to the broadcast transmitter device and broadcast by the latter. With this variant data is advantageously transmitted by the storage device or storage devices to the monitoring device only when a change has actually taken place. Possible status changes include, for example, the arrival of messages, the reading of messages or the deletion of new or already read messages. By summation of the individual transactions it is possible to generate in the monitoring device a map of the status in the storage device or storage devices at all times. Where appropriate, however, a synchronization process should be executed from time to time or as and when there is due cause in order to preclude any discrepancies between monitoring and storage device, for example due to a faulty data transmission.

An advantageous variant of the invention is also provided by means of a method,

wherein a notification newly received by the broadcast receiver device is compared with a previously received notification which has already been output on the output device, and

wherein the output of the new notification on the output device is suppressed if it is identical or the broadcast transmitter device is instructed by means of a corresponding return message to discontinue transmitting this notification.

In this way it is ensured that one and the same notification is indicated once only to the user in order to increase ease of use. Otherwise a message would be displayed several times, for example if the broadcast receiver device is switched on repeatedly. The output is therefore suppressed either purely on the receive side, in other words by the broadcast receiver device, or on the send side, in that the broadcast transmitter device is instructed to discontinue transmitting a notification.

Particularly advantageous is a variant of the invention,

wherein, when a notification is output, the user can optionally request a message on which the notification is based, and

wherein this message is transmitted upon request via an interface which is determined according to the message type and/or the message size.

In this case, in addition to the actual information about the presence of a message, the option is offered to request the message per se on which the notification is based since broadcast systems generally do not possess a return channel, though this is not to be excluded in principle here, a further communication channel is established and a request to provide the message is transmitted via this to the storage device. Possibilities here are Internet connections or also connections in a telephone network, both in wired networks and in mobile radio networks According to the invention a suitable transmit channel is subsequently determined according to the message type and/or the message size and the message is transmitted via this channel. In this way short messages, for example, can be transmitted via the broadcast transmitter device, while long messages can be transmitted over an Internet connection. Equally conceivable is the automatic setup of a telephone connection when a voice message is present. In principle, however, a message can also be transmitted over a single specified communication channel, in other words without consideration of message type and size.

It is advantageous if an address of the broadcast receiver device is provided as a user-specific identifier. In this case an address is assigned to each broadcast receiver device, during production for example, said address being used for receiving user-specific information. This is particularly convenient for the user since no user input is required in order to use the method according to the invention. An initialization can be performed for example such that the broadcast receiver device sets up a connection to the monitoring device via a return channel and automatically transmits the device address to the monitoring device.

It is also advantageous if the “multimedia home platform” standard is used by the broadcast transmitter device and the broadcast receiver device for transmitting the notification.

The standard named “Digital Video Broadcasting (DVB); Multimedia Home Platform (MHP) Specification 1.0.2”, 06/2002, which is available at www.etsi.org, represents an advantageous means of transmitting the user-specific notification within the framework of DVB, since the standard supports the transmission of user-specific data as well as enabling interactive television in general. The range of applications extends from the transmission of booked video films, the display of text information, such as the “Electronic Program Guide”, EPG for short, to the transmission of program applications written in the JAVA programming language and launched locally, in other words in the broadcast receiver device. According to the prior art, data of this kind can be received with the aid of what is called a “set-top box”. This device roughly corresponds to a computer with a hard disk together with a DVD drive and a DVB receiver unit. However, receiver units for terrestrial television or cable television are also possible. Furthermore it is of advantage if the set-top box includes a Connection means for a return channel, via Internet for example, or an analog or digital telephone connection. This return channel is essential to enable interactive television. The set-top box can also be addressed by the broadcast transmitter device via a device address assigned to it.

It should be pointed out in addition that the use of MHP in relation to the set-top box mentioned is by no means mandatory Rather, the use of a set-top box or a device similar to it for the application of the method according to the invention is also possible without the MHP standard.

It is also advantageous if, when there are a plurality of broadcast transmitter devices, each with a locally limited reception area, a notification concerning the user is transmitted by that broadcast transmitter device which is instructed to do so based on an identification process of the user at a broadcast receiver device in the reception area concerned, in particular by input of an access code or by means of an identity card.

The reception area of a broadcast service provider may be distributed over a plurality of broadcast transmitter devices which, on account of their transmit power for example, each cover only a part of the entire reception area. Due to the limited bandwidth it is unfavorable to transmit user-related data of all users from all the broadcast transmitter devices, since a user is normally in the reception area of only one broadcast transmitter device at a specific time. Therefore the user-related data of a user is advantageously transmitted by only one broadcast transmitter device, for example by the device which reaches the place of residence of the user concerned. From the outset, however, it cannot be ruled out that the user would also like to receive the notification about the presence of messages at a different location, for example when he is on vacation somewhere. Toward that end, an identification is input at a broadcast receiver device in the form of an access code which instructs the corresponding broadcast receiver device to transmit user-specific data for the user to whom the code is assigned. It is also conceivable for the identification to be performed by means of an identity card assigned to the user, which is inserted for the purpose of identification into a plug-in device of the broadcast receiver device.

The object of the invention is further achieved by a monitoring device

which has an interface to a storage device and an interface to a broadcast transmitter device,

which includes a detection module for determining the status of a storage device with regard to messages intended for a user which are stored there, and

which includes an indication module for generating a notification about the presence or the number of such messages and for transmitting this notification to the broadcast transmitter device.

The monitoring device forms an important component for implementing the method according to the invention. With its aid it is determined whether new messages are present for a user, and if required a notification about the presence of new messages is generated. The structural separation into detection module and indication module or into storage, monitoring and broadcast transmitter device is not mandatory Rather a grouping of these functional components, if appropriate also in a single device, is conceivable.

It is favorable here if the detection module is provided for monitoring the status of a storage device for receiving the number of the messages intended for a user and stored in the storage device, and in particular for the periodic request for this purpose.

With this variant the reception of the number of messages intended for a user is provided. At the same time the messages can additionally be differentiated according to, for example, read and unread messages. It is advantageous here that any storage device present can remain largely unmodified since its response in the case of this variant is more or less passive

It is also favorable it the detection module is provided for monitoring the status of a storage device for receiving a message concerning a status change in the storage device, in particular the arrival of messages, the reading of messages or the deletion of new or already read messages, and for the summation of the individual changes in status.

In this case the reception of a message concerning a change in status or transaction in the storage device is provided. An advantageous aspect with this detection module is that it can be kept comparatively simple in terms of its technical structure and that the status is determined not continuously but only as and when there is due cause. The detection module can further comprise a counting device which enables the status changes or transactions to be added up.

A particularly advantageous embodiment of the invention is produced with a monitoring device in which the indication module is provided for generating a notification which allows the optional request for a message on which the notification is based.

In this case the indication module has means which enable the generation of a notification which additionally includes functional components for the optional requesting of the message on which this notification is based. Control elements are therefore also contained in the notification in addition to the pure text information. This functionality is roughly comparable with the links known from hypertext documents and offers the user particularly easy access to his messages.

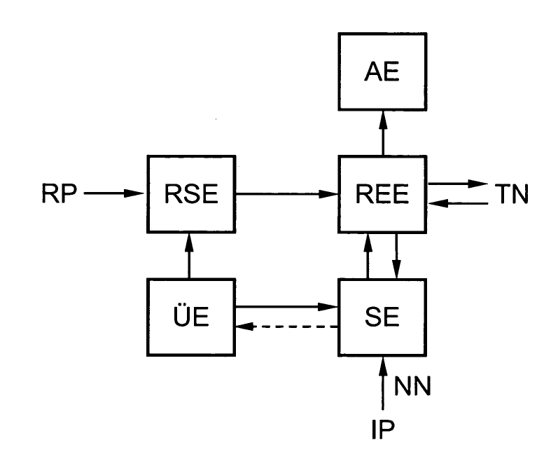

The invention will now be explained in more detail with reference to an exemplary embodiment shown in FIG. 1, which relates to the notification of a user about a message intended for him

FIG. 1 comprises a storage device SE, a monitoring device OE, a broadcast transmitter device RSE, a broadcast receiver device REE, and an output device AE.

The operating principle of the arrangement shown in FIG. 1 is as follows:

It is assumed that a new message NN is received and stored with the aid of the storage device SE. As a concrete example mention should be made here of an e-mail which is stored on a corresponding server and can be retrieved by the recipient. This process is symbolized by an arrow.

Independently of this, the number of messages intended for a user and stored in the storage device SF is determined on an ongoing basis by the monitoring device ÜE. This process is represented by a continuously drawn arrow from the monitoring device ÜF to the storage device SE.

As an option in relation to the method mentioned, however, The storage device SE can also be provided for reporting a new message NN. This is visualized by means of the dashed arrow drawn from the storage device SE to the monitoring device ÜE. There, the total number of stored messages can be calculated by summation.

Thus, if a new message NN is present, a corresponding notification is subsequently generated by the monitoring device ÜE and forwarded to the broadcast transmitter device RSE. This process is symbolized by means of arrow from the monitoring device ÜE to the broadcast transmitter device RSE. In the example shown the notification also contains control elements which enable the receiving user to request the stored message by simple means, for example by means of a so-called “link”. This is by no means mandatory, however.

Subsequently the notification is transmitted by the broadcast transmitter device RSE and received by the broadcast receiver device REE of the receiving user along with the broadcast program RP intended for the general public, filtered out from the data stream, transmitted to the output device AE and output on that device. The communication path is again symbolized by means of arrows, from the monitoring device ÜE via the broadcast transmitter device RSE and the broadcast receiver device REE to the output device AE. In the case of the broadcast transmitter device RSE the input of the broadcast program RP is additionally symbolized by means of an arrow.

To provide a better illustration, a satellite for digital television is specified as a concrete example for the broadcast transmitter device RSE, a set-top box for the broadcast receiver device REE, and a television for the output device AE. It is pointed out, however, that this concrete example should in no way be understood as restricting the general inventive idea.

The user and addressee of the received new message NN will—on the assumption that he is participating in the broadcast program, i.e. in the actual situation where he is watching television—be informed more or less synchronously about the presence of a new message NN, in that the notification will be inserted into the current broadcast program RP. The user, made aware in this way, thereupon requests the actual message NN from the storage device SE by activating the likewise incorporated links.

Subsequently the broadcast receiver device REE automatically sets up a connection to the storage device SE and transmits the request for the message NN. Since the new message NN in the example shown is comparatively large, it is not transmitted via the broadcast transmitter device RSE but directly from the storage device SE to the broadcast receiver device REE. To put it more precisely, owing to the limited capacity of the radio channel, normally only relatively small messages are transmitted via the broadcast transmitter system RSE. The transmission of the request along with the transmission of the new message NN is again symbolized in FIG. 1 by means of arrows between the broadcast receiver device REE and the storage device SE. For security reasons the sending of messages via the radio channel can however also be totally excluded or alternatively the encryption of messages can be provided.

Consequently even more communication paths can be provided for the broadcast receiver device REE, such as a connection to a mobile radio network, an Internet connection, a telephone connection and so on. This possibility of connection to a further telecommunications network TN is likewise symbolized by means of two arrows.

In this case the communication path to be used is specified, say, according to the message type, in other words, for example, an Internet connection for e-mails and a telephone communication for voice messages. Manual setup of the communication path is of course also possible for requesting the message, in other words, for example, a telephone call to the voice mail server without inclusion of the broadcast receiver REE or the retrieval of e-mails from a PC.

In addition to the request for a message by means of a link, it is also possible for a mailbox address to be stored in the broadcast receiver device REE and used for the connection setup to this address. This has the advantage that an access address to a mailbox, in the form of a link for example, will not be transmitted via the radio channel. In that case, namely, it would be possible in principle for anyone to receive the message and therefore there would be the potential for misuse

Finally it is also conceivable that the broadcast system itself possesses a return channel, in other words a direct communication path from the broadcast receiver device REE to the broadcast transmitter device RSE, and that the broadcast receiver device REE uses this return channel to transmit the request for the message NN.

1. Method for notifying a user about the presence of messages (NN) intended for him and stored in one or more storage devices (SE),
wherein the status of a storage device (SE) is monitored by a monitoring device (ÜE) and, depending on the result of the monitoring, a notification is generated which indicates the presence of a message (NN) or the number of messages (NN), in particular the number of new and read messages (NN),
characterized in that
this notification, provided with a user-specific identifier, is transmitted by a broadcast transmitter device (RSE), in particular on a periodically recurring basis,
this notification is filtered out from the received date according to the user-specific identifier by a broadcast receiver device (REE) assigned to the user, and
this notification is output on an output device (AE).

2. Method according to claim 1,
characterized in that, for the purpose of monitoring the status of a storage device (SE), the number of messages (NN) intended for a user and stored in the storage device (SE) is transmitted periodically by the storage device (SE) to the monitoring device (ÜE), in particular in response to a periodic request from the monitoring device (ÜE), or if there is a change in status in the storage device (SE).

3. Method according to one of claims 1 to 2,
characterized in that
a notification newly received by the broadcast receiver device (REE) is compared with a previously received notification which has already been output on the output device (AE), and
the output of the new notification on the output device (AE) is suppressed if it is identical or the broadcast transmitter device (RSE) is instructed by means of a corresponding return message to discontinue transmitting this notification.

4. Method according to one of claims 1 to 3,
characterized in that
when the notification is output, the user can optionally request a message (NN) on which the notification is based, and
this message (NN) is transmitted upon request via an interface which is determined according to the message type and/or the message size.

5. Method according to one of claims 1 to 4, characterized in that an address of the broadcast receiver device (REE) is provided as a user-specific address.

6. Method according to one of claims 1 to 5, characterized in that the “Multimedia Home Platform” standard is used by the broadcast transmitter device (RSE) and the broadcast receiver device (REE) for transmitting the notification.

7. Method according to one of claims 1 to 6, characterized in that when there are a plurality of broadcast transmitter devices (RSE), each with a locally limited reception area, a notification concerning the user is transmitted by that broadcast transmitter device (RSE) which is instructed to do so based on an identification process of the user at a broadcast receiver device (REE) in the reception area concerned, in particular by input of an access code or by means of an identity card.

8. Monitoring device (ÜE), characterized in that
it has an interface to a storage device (SE) and an interface to a broadcast transmitter device (RSE),
it includes a detection module for determining the status of a storage device (SE) with regard to messages (NN) intended for a user which are stored there, and
it includes an indication module for generating a notification about the presence or the number of such messages (NN) and for transmitting this notification to the broadcast transmitter device (RSE).

9. Monitoring device (ÜE) according to claim 8, characterized in that the detection module is provided for monitoring the status of a storage device (SE) for receiving the number of messages (NN) intended for a user and stored in the storage device (SE) and in particular for the periodic request for this purpose.

10. Monitoring device (ÜE) according to one of claims 8 to 9, characterized in that the indication module is provided for generating a notification which allows the optional requesting of a message (NN) on which the notification is based.
